(19) United States
(12) Patent Application Publication
(10) Pub. No.: US 2019/0337506 A1
(43) Pub. Date: Nov. 7, 2019

(54) PARKING CONTROL DEVICE, AND RECORDING MEDIUM

(71) Applicant: Panasonic Intellectual Property Management Co., Ltd., Osaka (JP)

(72) Inventors: TAKAHIRO SHIMA, Osaka (JP); SATOSHI FUKUMOTO, Tokyo (JP); YUSAKU TADA, Kanagawa (JP); MASATO INOUE, Kanagawa (JP); MANABU NAKAKITA, Kanagawa (JP)

(21) Appl. No.: 16/515,069

(22) Filed: Jul. 18, 2019

Related U.S. Application Data
(63) Continuation of application No. PCT/JP2018/001110, filed on Jan. 17, 2018.

(30) Foreign Application Priority Data
Jan. 27, 2017 (JP) 2017-013012

(51) Int. Cl. B60W 30/06; B60T 7/22; B62D 15/02

(52) U.S. Cl. CPC B60W 30/06; B62D 15/0285; B60T 7/22

(57) ABSTRACT

A parking control device includes a controller and a notification unit. The controller executes a parking assistance control for making a vehicle travel from a drop-off position of an occupant of the vehicle to a parking space that is preliminarily determined and making the vehicle be parked in the parking space by automated driving. The controller ceases the parking assistance control in a case where an obstacle is present on a traveling route of the vehicle including the parking space. The notification unit provides a notification that the parking assistance control is stopped. The notification unit transmits information indicating that the parking assistance control is ceased to a device having identification information preliminarily associated with identification information of the vehicle.

### CROSS-REFERENCE TO RELATED APPLICATIONS

This application is a continuation of the PCT International Application No. PCT/JP2018/001110 filed on Jan. 17, 2018, which claims the benefit of foreign priority of Japanese patent application No. 2017-013012, filed on Jan. 27, 2017, the contents all of which are incorporated herein by reference.

### TECHNICAL FIELD

The present disclosure relates to a parking control device, a program, and a recording medium for assisting parking of a vehicle.

### BACKGROUND ART

Conventionally, a device has been known that assists parking of a vehicle such as an automobile. For example, PTL 1 discloses a parking assistance device that detects an obstacle between a vehicle and a parking position, calculates a height of the obstacle, and determines whether the vehicle is accelerated or braked on the basis of the calculated result.

### CITATION LIST

### Patent Literature

### PTL 1: Unexamined Japanese Patent Publication No. 2013-244852

### SUMMARY

The present disclosure provides a parking control device, a program, and a recording medium capable of improving usability in a case where a vehicle travels from a drop-off position of an occupant to a parking space for parking by automated driving.

A parking control device according to the present disclosure includes a controller and a notification unit. The controller executes a parking assistance control for making a vehicle travel from a drop-off position of an occupant of the vehicle to a parking space that is preliminarily determined and making the vehicle be parked in the parking space by automated driving. The controller ceases the parking assistance control in a case where an obstacle is present on a traveling route of the vehicle including the parking space. The notification unit provides a notification that the parking assistance control is stopped. The notification unit transmits information indicating that the parking assistance control is ceased to a device having identification information preliminarily associated with identification information of the vehicle.

A program according to the present disclosure causes a computer to execute processing for executing a parking assistance control for making a vehicle travel from a drop-off position of an occupant of the vehicle to a parking space that is preliminarily determined and making the vehicle be parked in the parking space by automated driving. The program also causes a computer to execute processing for ceasing the parking assistance control in a case where an obstacle is present on a traveling route of the vehicle including the parking space during execution of the parking assistance control. The program further causes the computer to execute processing for providing a notification that the parking assistance control is ceased. In the processing for providing the notification, information indicating that the parking assistance control is ceased is transmitted to a device having identification information preliminarily associated with identification information of the vehicle.

A recording medium according to the present disclosure records therein a program that causes a computer to execute processing for executing a parking assistance control for making a vehicle travel from a drop-off position of an occupant of the vehicle to a parking space that is preliminarily determined and making the vehicle be parked in the parking space by automated driving. The recording medium also records therein a program that causes the computer to execute processing for ceasing the parking assistance control in a case where an obstacle is present on a traveling route of the vehicle including the parking space during execution of the parking assistance control. The recording medium further records therein a program that causes the computer to execute processing to provide a notification that the parking assistance control is ceased. In the processing for providing the notification, information indicating that the parking assistance control is ceased is transmitted to a device having identification information preliminarily associated with identification information of the vehicle.

The present disclosure makes it possible to improve usability in a case where a vehicle travels from a drop-off position of an occupant to a parking space for parking by automated driving.

### BRIEF DESCRIPTION OF DRAWINGS

FIG. 1 is a block diagram illustrating a configuration example of a parking control device according to an exemplary embodiment of the present disclosure.

FIG. 2 is a flowchart illustrating an operational example of the parking control device according to the exemplary embodiment of the present disclosure.

### DESCRIPTION OF EMBODIMENT

Before describing an exemplary embodiment of the present disclosure, a conventional technical problem will be simply described. The device of PTL 1 does not consider a case where a vehicle on which no occupant exists travels to a preliminarily specified parking space by automated driving for parking after a driver drops off at any position. Therefore, there is a room to improve usability.

### (Knowledge to Reach Present Disclosure)

For example, execution of a parking assistance control can be considered that, after a driver of a vehicle drops off from the vehicle at any place (hereinafter, drop-off position), makes a vehicle travel from the drop-off position to a preliminarily specified parking space and be parked in the parking space by automated driving.

However, during execution of the above-mentioned parking assistance control, in a case where an obstacle such as another vehicle is present on a traveling route of the vehicle or in a parking space, the parking assistance control can be disabled, but the driver (or manager of the vehicle) dropped-off is impossible to know that the parking assistance control is disabled. Accordingly, there is a room to improve usability.

Therefore, the present disclosure aims to improve usability in a case where a vehicle travels from a drop-off position of an occupant to a preliminarily specified parking space by automated driving for parking.

### Exemplary Embodiment

Hereinafter, an exemplary embodiment of the present disclosure will be described with reference to the drawings.

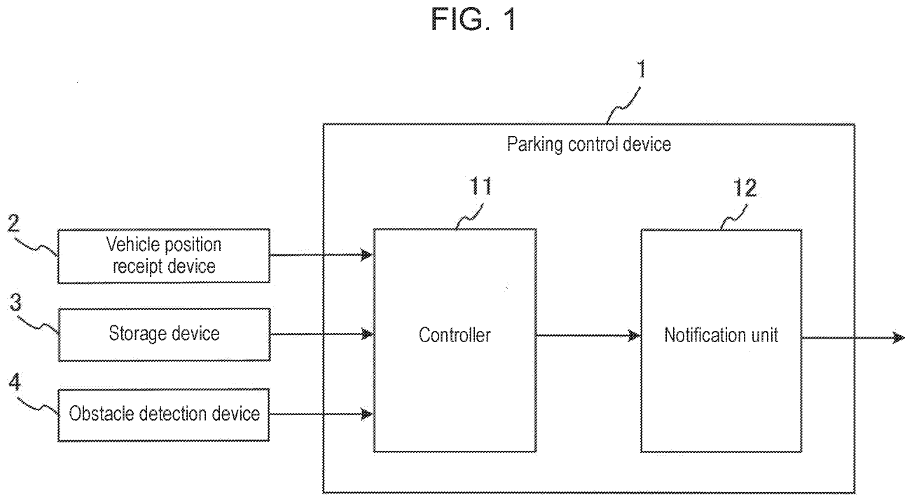

First, a configuration of parking control device 1 according to the exemplary embodiment will be described with reference to FIG. 1. FIG. 1 is a block diagram illustrating a configuration example of parking control device 1 according to the present exemplary embodiment.

Parking control device 1, vehicle position receipt device 2, storage device 3, and obstacle detection device 4 illustrated in FIG. 1 are mounted on, for example, a vehicle such as an automobile.

Vehicle position receipt device 2 receives a present position of the vehicle, and outputs information indicating the present position (hereinafter, referred to as vehicle position information) to parking control device 1. An example of vehicle position receipt device 2 includes a global positioning system (GPS).

Storage device 3 stores three-dimensional map information (hereinafter, simply referred to as map information) and information indicating a position of a preliminarily determined parking space (hereinafter, referred to as parking position information). The three-dimensional map information and the parking position information are read out by parking control device 1. An example of storage device 3 includes a non-volatile memory.

Obstacle detection device 4 detects an obstacle that is present on a traveling route of the vehicle. Then, obstacle detection device 4 outputs information indicating that the obstacle is detected (hereinafter, obstacle information) to parking control device 1. The traveling route of the vehicle herein includes a preliminarily determined parking space. Also, the obstacle herein is a stationary object having a size to prevent traveling of the vehicle. Examples of obstacle detection device 4 include a radar, a sonar, a camera, and the like.

Although omitted in the drawing, parking control device 1 includes, for example, a central processing unit (CPU), a recording medium such as a read only memory (ROM) storing a control program, a working memory such as a random access memory (RAM), and a communication circuit. Each function (detail thereof will be described below) of controller 11 and notification unit 12 illustrated in FIG. 1 is implemented by the CPU executing the control program.

Note that the control program may be stored in a recording medium such as a digital versatile disc (DVD) or a universal serial bus (USB) memory to be provided, or may be stored in a server device on a network so as to be able to be downloaded via the network.

Parking control device 1 includes controller 11 and notification unit 12.

Controller 11 receives vehicle position information from vehicle position receipt device 2 and receives (reads out) parking position information and map information from storage device 3 when an execution instruction operation of the above-mentioned parking assistance control (hereinafter, simply referred to as execution instruction operation) is performed by, for example, a driver.

The driver performs the execution instruction operation on, for example, an operation device mounted on the vehicle or a terminal device owned by the driver (which are not shown). Upon execution of the execution instruction operation, the operation device or the terminal device outputs (transmits) information indicating that the execution instruction operation is performed to controller 11.

Controller 11 calculates a route (hereinafter, referred to as traveling route) between a present position (drop-off position) indicated by the vehicle position information and a position of the parking space indicated by the parking position information with reference to the map information. The traveling route, which is the shortest route as an example, is calculated. As described above, the traveling route also includes the parking space.

Controller 11 starts parking assistance control on the basis of the calculated traveling route. This makes the vehicle be controlled so as to travel the calculated traveling route by automated driving.

The controller 11 determines whether an obstacle is present on the traveling route (route on which the vehicle has not been traveled) while the vehicle travels the traveling route. For example, controller 11 determines that an obstacle is present on the traveling route when obstacle information is received from obstacle detection device 4.

Controller 11 causes the vehicle to cease parking in a parking space (parking assistance control) when an obstacle is present on the traveling route. In this case, controller 11 also provides a notification that parking is ceased to notification unit 12. Herein, “cease” indicates that traveling on a remaining traveling route is not performed.

Controller 11 may control the vehicle to make the parking assistance control is interrupted before ceasing parking in a parking space (parking assistance control) when an obstacle is present on the traveling route. For example, controller 11 causes the vehicle to stop at a position away from the obstacle that is present on the traveling route by a predetermined distance while making the vehicle keep the traveling route. In this case, controller 11 also provides a notification that parking is interrupted to notification unit 12. Herein, “interruption” indicates that the vehicles is stopped while keeping the traveling route. After interruption, when the obstacle on the traveling route becomes absence, the vehicle is in a state capable of traveling on the remaining traveling route from the position for restarting the parking assistance control.

Controller 11 causes the vehicle to complete parking in the parking space (parking assistance control) when no obstacle is present on the traveling route. This makes the vehicle be parked in the parking space. In this case, the controller 11 also provides a notification that parking is completed to notification unit 12.

Upon receiving a notification that ceasing is interrupted from controller 11, notification unit 12 provides a notification that parking is interrupted.

For example, notification unit 12 outputs a sound (siren or horn) or voice message indicating that parking is interrupted from a speaker mounted on the vehicle.

Upon receiving a notification that parking is ceased from controller 11, notification unit 12 provides a notification that parking is ceased.

For example, notification unit 12 outputs a sound (siren) indicating that parking is cased from a speaker mounted on the vehicle. Alternatively, for example, notification unit 12 transmits notification information indicating that parking is ceased to a predetermined external device. The predetermined external device is, for example, a terminal device owned by the driver, a terminal device (server) owned by a manager of the vehicle, or the like. Herein the terminal device owned by the manager of the vehicle may be included in a management system of a valley park.

Upon receiving a notification that parking is completed from controller 11, notification unit 12 provides a notification that parking is completed.

For example, notification unit 12 transmits notification information indicating that parking is completed to the above-mentioned predetermined external device.

The configuration of parking control device 1 according to the exemplary embodiment is described above.

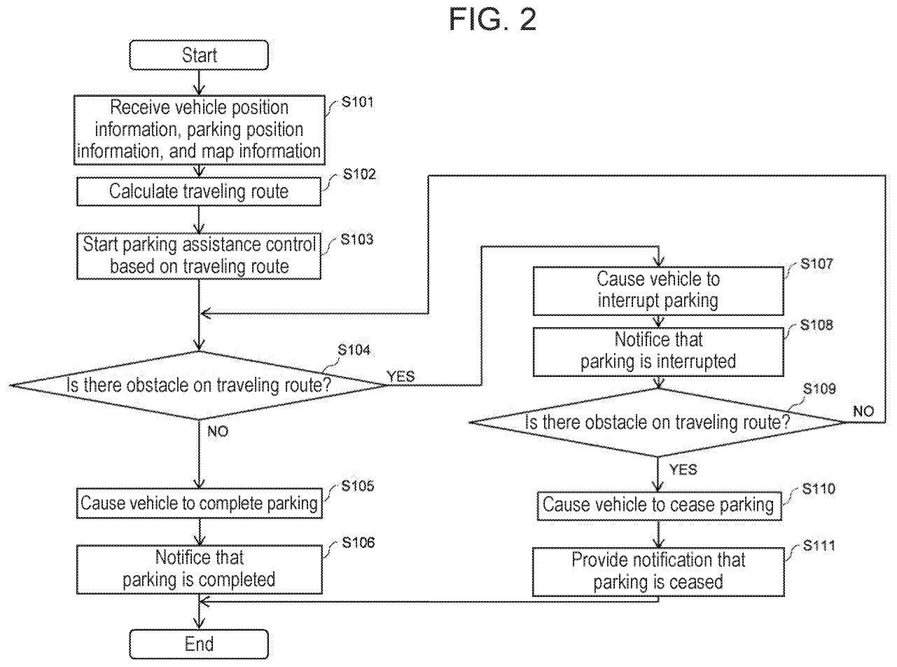

Next, operation of parking control device 1 according to the exemplary embodiment will be described with reference to FIG. 2. FIG. 2 is a flowchart illustrating an operational example of parking control device 1 according to the exemplary embodiment.

First, when the execution instruction operation is performed by the driver, controller 11 receives vehicle position information from vehicle position receipt device 2 and receives parking position information and map information from storage device 3 (step S101).

Next, controller 11 calculates, with reference to the map information, a traveling route that is a route between the present position (drop-off position) indicated by the vehicle position information and a position of a parking space indicated by the parking position information (step S102).

Next, controller 11 starts the parking assistance control on the basis of the traveling route calculated (step S103). This makes the vehicle be controlled to travel the calculated traveling route by automated driving.

Next, controller 11 determines whether an obstacle is present on the traveling route (route on which the vehicle has not been traveled) (step S104). The determination processing is performed while the vehicle travels on the traveling route.

When no obstacle present on the traveling route (NO in step S104), controller 11 causes the vehicle to complete parking in the parking space (parking assistance control) (step S105). This makes the vehicle be parked in the parking space.

Next, notification unit 12 provides a notification that parking is completed (step S106).

In contrast, when an obstacle is present on the traveling route (YES in step S104), controller 11 causes the vehicle to interrupt parking in the parking space (parking assistance control) (step S107).

Next, the notification unit 12 provides a notification that parking is interrupted (step S108). This makes it possible to provide a notification that the obstacle is required to be moved to someone therearound by the notification that parking is interrupted (e.g., horn, etc.) notified by notification unit 12.

Then, controller 11 determines whether an obstacle is present on the traveling route (route on which the vehicle has not been traveled) (step S109). This determination processing is performed by one time or a plurality of times during a predetermined time after the vehicle provides a notification indicating interruption. This makes it possible to determine whether the obstacle is moved by a notification that parking is interrupted notified by notification unit 12. Furthermore, when the obstacle is moved due to the notification that parking is interrupted notified by notification unit 12, the parking assistance control can be restarted.

After notification is provided that the parking assistance control is interrupted, when no obstacle is present on the traveling route (NO in step S109), controller 11 restarts interrupted parking in the parking space (parking assistance control), and returns to a control to determine whether an obstacle is present on the remaining traveling route (step S104). A case where a determination is made that no obstacle is present in step S109 denotes that no obstacle becomes present. In a case where an obstacle is continuously present on the traveling route (YES in step S109), controller 11 causes the vehicle to cease parking in the parking space (parking assistance control (step S110). A case where a determination is made that an obstacle is present in step S109 denotes that an obstacle is still present.

Next, notification unit 12 provides a notification that parking is ceased (step S111).

The operation of parking control device 1 according to the exemplary embodiment is described above.

As described in detail, parking control device 1 according to the exemplary embodiment provides a notification that the parking assistance control is ceased in a case where an obstacle is present on the traveling route of the vehicle including the parking space during execution of the parking assistance control to make the vehicle travel from a drop-off position of the occupant of the vehicle to a predetermined parking space and make the vehicle be parked in the parking space by automated driving. This enables the driver, etc., to notice that the parking assistance control is ceased, resulting in increase of usability.

Parking control device 1 according to the present exemplary embodiment also interrupts the parking assistance control before determining that the parking assistance control is ceased to facilitate that an obstacle is moved when the obstacle is present on the traveling route of the vehicle including the parking space during execution of the parking assistance control to make the vehicle be parked in the parking space. This makes it possible to restart the parking assistance control to complete the parking assistance control in a case where the obstacle is moved instead of ceasing the parking assistance control at a time when determination is made that an obstacle is present. This further improves usability.

The present disclosure is not limited to the above-mentioned exemplary embodiment, and various modifications are possible. Hereinafter, various modifications will be described.

### First Modification

In the above-mentioned exemplary embodiment, the example is described in which controller 11 calculates a traveling route on the basis of the vehicle position information, the parking position information, and the map information. However, traveling route information indicating traveling route may be preliminarily prepared.

The traveling route information is information indicating a traveling route between a preliminarily determined drop-off position and a position of a preliminarily determined parking space. Accordingly, the traveling route information includes the parking position information.

Controller 11 reads out the traveling route information from storage device 3 and starts the parking assistance control on the basis of a traveling route indicated by the traveling route information when an execution instruction operation is performed.

### Second Modification

In the above-mentioned exemplary embodiment, notification unit 12 may transmit the notification information to an external device having identification information preliminarily associated with identification information of the vehicle. The notification information is, for example, information indicating that the parking assistance control is ceased in a case where the parking assistance control is ceased.

### Third Modification

In the above-mentioned exemplary embodiment, the example is described in which obstacle detection device 4 is mounted on a vehicle, but this is not limited thereto. For example, obstacle detection device 4 may be equipped on the traveling route (including parking space) or a vicinity thereof.

### Fourth Modification

In the above-mentioned exemplary embodiment, controller 11 may further determine, when determining that an obstacle is present on the traveling route (YES in step S104 in FIG. 2), whether the obstacle is a living body (e.g., human, animal) on the basis of detection information from an infrared rays sensor (activity amount sensor) not shown. When the obstacle is a living body, notification unit 12 emits a warning sound, etc., from a speaker mounted on the vehicle. This enables, for example, the human or the animal present on the traveling route to move. In contrast, when the obstacle is not a living body, the processing of above-mentioned step S107, S108 is performed.

### Fifth Modification

The notification information may include information indicating the position of the obstacle. The position of the obstacle is detected by obstacle detection device 4 and made to be included in the obstacle information to be output to controller 11. Then, controller 11 makes the information of the position of the obstacle be included in the notification information to output it to a predetermined external device when parking is ceased. This enables the driver, etc., to know the place where the obstacle is present.

### Sixth Modification

Steps S107 and S108 in FIG. 2 may be omitted. When the obstacle is moved after passage of time, the parking assistance control can be restarted to complete it without generating noise around the vehicle.

### INDUSTRIAL APPLICABILITY

The present disclosure is suitable for a parking control device, a parking control program, and a recording medium for assisting parking of a vehicle.

### REFERENCE MARKS IN THE DRAWINGS

1 parking control device
2 vehicle position receipt device
3 storage device
4 obstacle detection device
11 controller
12 notification unit

1. A parking control device comprising:
a controller that executes by automated driving a parking assistance control for making a vehicle travel from a drop-off position of an occupant of the vehicle to a parking space that is preliminarily determined and making the vehicle be parked in the parking space, the controller ceasing the parking assistance control in a case where an obstacle is present on a traveling route of the vehicle including the parking space; and
a notification unit that provides a notification that the parking assistance control is ceased,
wherein the notification unit transmits information indicating that the parking assistance control is ceased to a device having identification information preliminarily associated with identification information of the vehicle.

2. The parking control device according to claim 1, wherein the controller interrupts the parking assistance control before the parking assistance control is ceased in a case where an obstacle is present on the traveling route of the vehicle including the parking space.

3. The parking control device according to claim 2, wherein the controller restarts the parking assistance control in a case where the obstacle becomes absence after the interruption.

4. The parking control device according to claim 1, wherein the notification unit notifies the device of information indicating a position of the obstacle.

5. The parking control device according to claim 2, wherein the notification unit outputs a sound indicating interruption of the parking assistance control.

6. The parking control device according to claim 1, wherein the obstacle is a stationary object detected by a predetermined sensor.

7. A non-transitory recording medium recording that stores a program that causes a computer to execute processing, the processing comprising:
executing by automated driving a parking assistance control for making a vehicle travel from a drop-off position of an occupant of the vehicle to a parking space that is preliminarily determined and making the vehicle be parked in the parking space,
ceasing the parking assistance control in a case where an obstacle is present on a traveling route of the vehicle including the parking space during execution of the parking assistance control, and
providing a notification that the parking assistance control is ceased,
wherein in the processing for providing a notification, information indicating that the parking assistance control is ceased is transmitted to a device having identification information preliminarily associated with identification information of the vehicle.

8. A parking control device that executes a parking assistance control to a vehicle, the parking control device comprising:
a controller that executes the parking assistance control for making the vehicle travel on a traveling route from a position to start the parking assistance control of the vehicle to a parking space that is preliminarily determined and making the vehicle be parked in the parking space, and ceases the parking assistance control in a case where an obstacle is present on the traveling route of the vehicle including the parking space; and
a notification unit for providing a notification that the parking assistance control is ceased,
wherein the notification unit transmits information indicating that the parking assistance control is ceased to a device having identification information preliminarily associated with identification information of the vehicle.

9. A method of executing a parking assistance control to a vehicle, the method comprising:
executing the parking assistance control for making the vehicle travel a traveling route from a position to start the parking assistance control of the vehicle to a parking space that is preliminarily determined and making the vehicle be parked in the parking space;
ceasing the executing of the parking assistance control in a case where an obstacle is present on the traveling route of the vehicle including the parking space;
providing a notification of the ceasing; and
transmitting information indicating the ceasing to a device having identification information preliminarily associated with identification information of the vehicle.
